(19) United States
(12) Patent Application Publication
(10) Pub. No.: US 2017/0083928 A1
(43) Pub. Date: Mar. 23, 2017

(54) METHOD AND SYSTEM FOR ANALYSIS OF IMMIGRATION PATTERNS

(71) Applicant: MasterCard International Incorporated, Purchase, NY (US)

(72) Inventors: Jean-Pierre GERARD, Croton-On-Hudson, NY (US); Po HU, Norwalk, CT (US); Arun ELANGOVAN, Astoria, NY (US)

(73) Assignee: MasterCard International Incorporated, Purchase, NY (US)

(21) Appl. No.: 14/862,710

(22) Filed: Sep. 23, 2015

(51) Int. Cl. G06Q 30/02

(52) U.S. Cl. CPC G06Q 30/0202; G06Q 30/0205

(57) ABSTRACT

A method for predictive modeling of consumer immigration includes: storing transaction messages, each including a common primary account number, a merchant country, an issuer country, a transaction date, and additional data elements; identifying a first subset of transaction messages where the merchant is different from the issuer country; identifying a second subset of transaction messages where the merchant country is the same as the issuer country; determining, by the processing device of the processing server, an immigration date based on a comparison of a transaction frequency of transaction messages in each of the first subset and the second subset; identifying purchase behaviors based on data stored in each transaction message where the transaction date is earlier than the immigration date; and generating a predictive model configured to be applicable to transaction data to determine a likelihood of immigration based on the purchase behaviors.

### FIELD

The present disclosure relates to the analysis of immigration patterns using cross-border transactions, specifically the generation of a predictive model for detecting a likelihood of immigration based on frequency of cross-border transactions and use thereof in predicting immigration for a consumer based on transaction behaviors.

### BACKGROUND

Merchants, retailers, manufacturers, advertisers, researchers, content providers, and other entities often seek out as much knowledge about an individual or group of individuals as possible, in order to provide for better research, better targeted advertising, etc. For example, by learning a person's hobbies, advertisements and offers that are more specifically tailored to that person's hobbies can be identified and presented to the person, resulting in a higher rate of return. One of the most valuable data points about an individual can often be where the individual lives. Because of the availability of merchants and products can vary from place to place, identifying what city or even what country an individual lives in can be of great importance to advertisers and other entities.

Many methods have been established to identify a city or country of residence for a consumer. Such methods can include analyzing the geographic location of payment transactions involving transaction accounts associated with the consumer, analyzing the geographic location of a mobile device, such as a cellular phone, associated with the consumer, or by retrieving data from publically available sources, such as census data. However, such methods are often ineffective if the consumer moves to a new country. As many consumers vacation abroad, existing methods may often identify a consumer transacting in another country as just visiting. Because vacations may vary in length, and because publically available data that indicates where an individual lives may have a long delay in updating, a consumer may move to a new country months before they are identified by such methods as living in the new country. In the meantime, offers and advertisements may still be tailored to the individual based on their prior country, which may thus be highly ineffective.

Thus, there is a need for a technical solution to more quickly identify when a consumer is immigrating to a new country. By providing systems configured to use predictive modeling of consumer transaction behavior for individuals known to have moved to a new country, other individuals that are moving may be more quickly identified, potentially before the actual move takes place. Such information may be useful for data analysis by governmental agencies, research centers, advertisers, content providers, and others. Accordingly, the use of predictive modeling for identifying immigration based on transactional data may provide for significant improvements over existing methods and systems.

### SUMMARY

The present disclosure provides a description of systems and methods for predictive modeling of consumer immigration and use thereof in identifying immigrating consumers.

A method for predictive modeling of consumer immigration includes: storing, in a transaction database of a processing server, a plurality of transaction messages for payment transactions involving a consumer, wherein each transaction message is formatted based on one or more standards and includes a plurality of data elements including at least a first data element configured to store a common primary account number, a second data element configured to store a merchant country, a third data element configured to store an issuing financial institution country, a fourth data element configured to store a transaction date, and one or more additional data elements configured to store transaction data; executing, by a processing device of the processing server, a first query on the transaction database to identify a first subset of transaction messages where the merchant country stored in the second data element is different from the issuing financial institution country stored in the third data element; executing, by the processing device of the processing server, a second query on the transaction database to identify a second subset of transaction messages where the merchant country stored in the second data element is the same as the issuing financial institution country stored in the third data element; determining, by the processing device of the processing server, an immigration date based on a comparison of a transaction frequency of transaction messages in each of the first subset and the second subset based on the transaction date stored in the fourth data element included in the transaction messages in the respective subset, wherein (i) a transaction frequency of transaction messages in the first subset where the transaction date stored in the fourth data element is earlier than the immigration date is lesser than a transaction frequency of transaction messages in the first subset where the transaction date stored in the fourth data element is later than the immigration date, and (ii) a transaction frequency of transaction messages in the second subset where the transaction date stored in the fourth data element is earlier than the immigration date is greater than a transaction frequency of transaction messages in the second subset where the transaction date stored in the fourth data element is later than the immigration date; identifying, by the processing device of the processing server, one or more purchase behaviors for the common primary account number based on data stored in one or more of the plurality of data elements included in each transaction message in the transaction database where the transaction date stored in the fourth data element is earlier than the immigration date; and generating, by the processing device of the processing server, a predictive model configured to be applicable to transaction data to determine a likelihood of immigration, wherein the predictive model is based on the identified one or more purchase behaviors.

A method for identification of potential immigrating consumers using predictive modeling includes: storing, in a model database of a processing server, one or more predictive models, wherein each predictive model is configured to be applicable to transaction data to determine a likelihood of immigration; storing, in a transaction database of the processing server, a plurality of transaction messages, wherein each transaction message is formatted based on one or more standards and includes a plurality of data elements including at least a first data element configured to store a primary account number, a second data element configured to store a merchant country, a third data element configured to store an issuing financial institution country, a fourth data element configured to store a transaction date, and one or more additional data elements configured to store transaction data; receiving, by a receiving device of the processing server, an electronic signal comprising an immigration data request, wherein the immigration data request includes at least a first country; executing, by a processing device of the processing server, a query on the transaction database to identify a plurality of subsets of transaction messages where one of the merchant country stored in the second data element and the issuing financial institution country stored in the third data element included in the respective transaction message is the first country included in the received immigration data request, wherein the first data element included in each transaction message in each of the plurality of subsets includes a common primary account number; applying, by the processing device of the processing server, at least one predictive model stored in the model database to each subset of the identified plurality of subsets to determine a corresponding likelihood of immigration based on data stored in one or more of the plurality of data elements included in each transaction message in the respective subset; and electronically transmitting, by a transmitting device of the processing server, a data signal comprising immigration data in response to the received immigration data request, wherein the immigration data is based on at least the determined likelihood of immigration corresponding to each subset of the identified plurality of subsets.

A system for predictive modeling of consumer immigration includes a transaction database of a processing server configured to store a plurality of transaction messages for payment transactions involving a consumer, wherein each transaction message is formatted based on one or more standards and includes a plurality of data elements including at least a first data element configured to store a common primary account number, a second data element configured to store a merchant country, a third data element configured to store an issuing financial institution country, a fourth data element configured to store a transaction date, and one or more additional data elements configured to store transaction data, and a processing device of the processing server configured to: execute a first query on the transaction database to identify a first subset of transaction messages where the merchant country stored in the second data element is different from the issuing financial institution country stored in the third data element; execute a second query on the transaction database to identify a second subset of transaction messages where the merchant country stored in the second data element is the same as the issuing financial institution country stored in the third data element; determine an immigration date based on a comparison of a transaction frequency of transaction messages in each of the first subset and the second subset based on the transaction date stored in the fourth data element included in the transaction messages in the respective subset, wherein (i) a transaction frequency of transaction messages in the first subset where the transaction date stored in the fourth data element is earlier than the immigration date is lesser than a transaction frequency of transaction messages in the first subset where the transaction date stored in the fourth data element is later than the immigration date, and (ii) a transaction frequency of transaction messages in the second subset where the transaction date stored in the fourth data element is earlier than the immigration date is greater than a transaction frequency of transaction messages in the second subset where the transaction date stored in the fourth data element is later than the immigration date; identify one or more purchase behaviors for the common primary account number based on data stored in one or more of the plurality of data elements included in each transaction message in the transaction database where the transaction date stored in the fourth data element is earlier than the immigration date; and generate a predictive model configured to be applicable to transaction data to determine a likelihood of immigration, wherein the predictive model is based on the identified one or more purchase behaviors.

A system for identification of potential immigrating consumers using predictive modeling includes a model database, a transaction database, a receiving device, a processing device, and a transmitting device of a processing server. The model database of the processing server is configured to store one or more predictive models, wherein each predictive model is configured to be applicable to transaction data to determine a likelihood of immigration. The transaction database of the processing server is configured to store a plurality of transaction messages, wherein each transaction message is formatted based on one or more standards and includes a plurality of data elements including at least a first data element configured to store a primary account number, a second data element configured to store a merchant country, a third data element configured to store an issuing financial institution country, a fourth data element configured to store a transaction date, and one or more additional data elements configured to store transaction data. The receiving device of the processing server is configured to receive an electronic signal comprising an immigration data request, wherein the immigration data request includes at least a first country. The processing device of the processing server is configured to: execute a query on the transaction database to identify a plurality of subsets of transaction messages where one of the merchant country stored in the second data element and the issuing financial institution country stored in the third data element included in the respective transaction message is the first country included in the received immigration data request, wherein the first data element included in each transaction message in each of the plurality of subsets includes a common primary account number; and apply at least one predictive model stored in the model database to each subset of the identified plurality of subsets to determine a corresponding likelihood of immigration based on data stored in one or more of the plurality of data elements included in each transaction message in the respective subset. The transmitting device of the processing server is configured to electronically transmit a data signal comprising immigration data in response to the received immigration data request, wherein the immigration data is based on at least the determined likelihood of immigration corresponding to each subset of the identified plurality of subsets.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the generating and use of predictive models of consumer immigration based on cross-border transactions in accordance with exemplary embodiments.

FIG. 2 is a block diagram illustrating the processing server of FIG. 1 for the generation and use of predictive models for consumer immigration in accordance with exemplary embodiments.

FIG. 3 is a flow diagram illustrating a process for generating a predictive model for consumer immigration using transaction data using the processing server of FIG. 2 in accordance with exemplary embodiments.

FIG. 4 is a flow diagram illustrating a process for identifying immigrating consumers using predictive modeling and transaction behavior using the processing server of FIG. 2 in accordance with exemplary embodiments.

FIG. 5 is a flow diagram illustrating an exemplary method for predictive modeling of consumer immigration based on transactional data in accordance with exemplary embodiments.

FIG. 6 is a flow chart illustrating an exemplary method for identification of potential immigrating consumers by transactional data using predictive modeling in accordance with exemplary embodiments.

FIG. 7 is a flow diagram illustrating the processing of a payment transaction in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Predictive Modeling of Immigration Based on Transaction Behavior

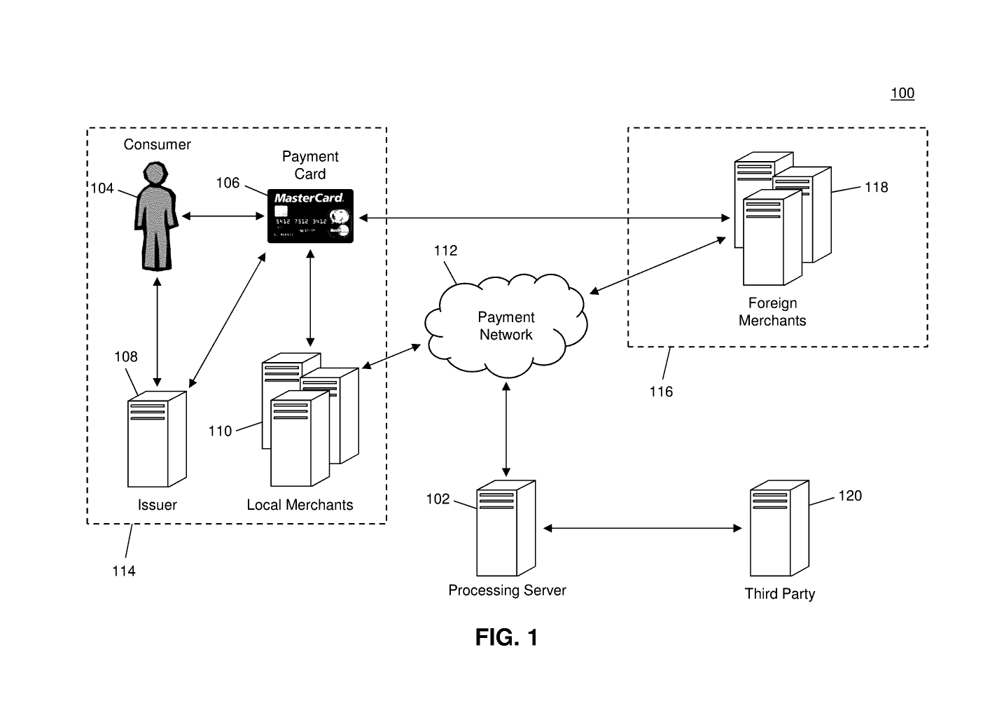

FIG. 1 illustrates a system 100 for the generation of predictive models for consumer immigration based on transaction behavior including cross-border transactions, and use thereof in the identification of potentially immigrating consumers based on transaction behavior.

The system 100 may include a processing server 102. The processing server 102, discussed in more detail below, may be configured to utilize transaction behavior including the frequency of cross-border transactions for known immigrating consumers to generate predictive models to predict consumer likelihood of immigration. In the system 100, a consumer 104 may be associated with one or more payment cards 106 or other payment instruments that may be used to fund a payment transaction. Each payment card 106 associated with the consumer 104 may correspond to a transaction account associated with the consumer 104. Each transaction account may be held by an issuer 108. The issuer 108 may be a financial institution, such as an issuing bank, or other entity that owns, manages, or is otherwise associated with transaction accounts, including transaction accounts for which payment instruments such as the payment card 106 are issued.

The consumer 104 may visit local merchants 110 and present the payment card 106 for use in funding payment transactions. In some embodiments, the transactions may be in-person transactions, such as at physical storefronts of the local merchants 110, remote transactions, such as conducted via telephone, mail order, the Internet, or other suitable method, or a combination thereof. The payment card 106 may be presented by providing a physical card to the local merchant 110, which may read payment details from the payment card 106 using a magnetic stripe reader or other suitable method, by electronically transmitting payment details associated with the payment card 106 to the local merchant 110 using an electronic device, such as a cellular phone or smart phone configured to electronically transmit payment details via near field communication (NFC), Bluetooth, radio frequency, etc., or any other suitable method for the conveyance of payment details associated with a payment card 106 to a local merchant 110.

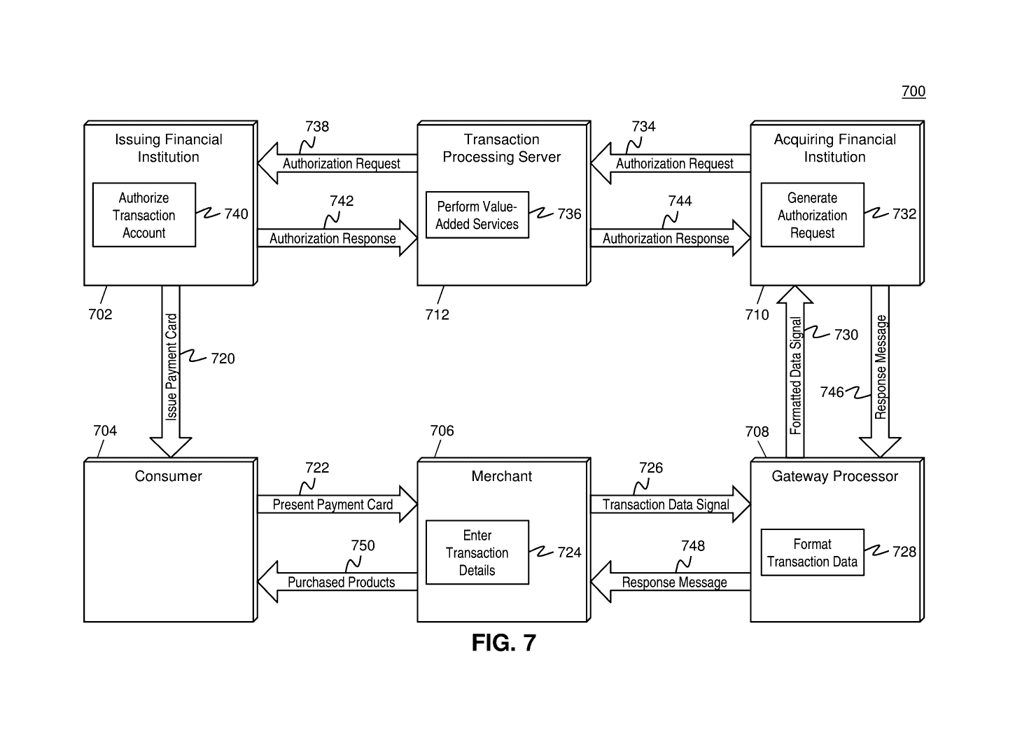

The local merchant 110 may then initiate a payment transaction involving the consumer 104 using a point of sale system or other suitable computing system or device where the payment details associated with the payment card 106 are submitted for use in funding the payment transaction. Transaction details for the payment transaction may be submitted to a payment network 112 for processing. The payment network 112 may process the payment transaction using traditional methods and systems, such as discussed in more detail below with respect to the process 700 illustrated in FIG. 7 for the processing of payment transactions. For instance, the payment network 112 may contact the issuer 108 associated with the payment card 106 for authorization of the payment transaction based on, for example, an available credit limit and the amount of the transaction. The result of the processing of the payment transaction may be provided to the local merchant 110, which may finalize the transaction with the consumer 104.

In the system 100, local merchants 110 may be merchants that are included in a first country 114, where the first country 114 is a country that includes the issuer 108 that issued the payment card 106 to the consumer 104. In instances where an issuer 108 may be located in multiple countries, the first country 114 may be the country associated with the issued payment card 106. The country of issue of a payment card 106 may be identified based on a transaction account number of the payment card. For example, the transaction account number may include a bank identification number, and/or product identification, which may indicate the country of issuance.

The consumer 104 may also conduct payment transactions with foreign merchants 118 located in a second country 116. Payment transactions may be initiated at the foreign merchants 118, which may submit the payment transactions to the payment network 112 for processing. The payment network 112 may process the payment transactions, which may be considered cross-border transactions, using traditional methods and systems. A payment transaction may be considered a cross-border transaction when the country (e.g., the second country 116) associated with the merchant involved in the payment transaction is different from the country of issuance (e.g., the first country 114) of the payment card 106 used to fund the payment transaction and/or the country of the issuer 108 associated with the payment card 106. Cross-border transactions may be processed the same as or similarly to standard payment transactions, but may include additional processing, such as for the conversion of currency in instances where the first country 114 and second country 116 may use different currencies.

The processing server 102 may be configured to identify when a consumer 104 immigrates from the first country 114 to the second country 116 based on the frequency of cross-border transactions, and may analyze the transaction behavior of the consumer 104 prior to a date of immigration to generate a predictive model for use in identifying likelihood of immigration for other consumers 104. The processing server 102 may receive transaction data electronically transmitted from the payment network 112 for payment transactions involving the consumer 104. The transaction data may be electronically transmitted to the processing server 102 as transaction messages, and may utilize the infrastructure of the payment network 112 known as the payment rails, discussed in more detail below. Transaction messages may be specially formatted data signals that are formatted based on one or more standards, such as the International Organization of Standardization's ISO 8583 standard, that include a plurality of data elements, each data element being configured to store data as set forth in the associated standards. Transaction messages may also include additional data, such as addendum data, message type indicators indicative of a type of the transaction message, etc.

Each transaction message may include a data element configured to store a primary account number associated with the transaction account used to fund the related payment transaction, a data element configured to store a country associated with the merchant involved in the payment transaction, a data element configured to store a country associated with the issuer 108 associated with the transaction account used to fund the payment transaction, a data element configured to store a date, and additional data elements that may store additional transaction data, such as a transaction amount, product data, point of sale data, a geographic location, merchant data, consumer data, loyalty data, reward data, offer data, etc. In some embodiments, the processing server 102 may be a part of the payment network 112 and may receive the transaction messages using internal communication of the payment network 112. In such embodiments, the processing server 102 may be configured to process payment transactions as part of the payment network, as discussed in more detail below with respect to the process 700 illustrated in FIG. 7.

The processing server 102 may be configured to identify transaction messages for payment transactions involving the consumer 104 based on the primary account number stored in the corresponding data element of each transaction message. The processing server 102 may then separate the transaction messages into two groups. The first group may consist of transaction messages for local transactions where the involved merchant is a local merchant 110 included in the same country (e.g., the first country 114) as the country of issuance for the payment card 106. The second group may consist of transaction messages for cross-border transactions where the involved merchant is a foreign merchant 118 included in a different country (e.g., the second country 116) as the country of issuance. In some instances, the processing server 102 may identify multiple groups of cross-border transactions, with each group being associated with a different country where the involved foreign merchant 118 is located. The grouping of transaction messages may be based on the merchant country included in the corresponding data element included in the respective transaction message.

The processing server 102 may then analyze the transaction dates stored in the corresponding data element for each transaction message to identify an immigration date. The immigration date may be determined based on a frequency of local transactions compared to a frequency of cross-border transactions. For example, the processing server 102 may identify transaction frequency over multiple periods of time (e.g., one month intervals). If the frequency of cross-border transactions is higher than the frequency of local transactions through an interval or consecutive intervals, the processing server 102 may determine that the consumer 104 immigrated at a date at or near the beginning of the period of time when the frequency of cross-border transactions increased. In another example, the processing server 102 may identify when the frequency of cross-border transactions is higher than the frequency of local transactions, and when the frequency of local transactions is below a predetermined threshold, such as may be set by the processing server 102 or other entity. For instance, if the frequency of local transactions is such that local transactions only occur once every other month, the processing server 102 may identify the immigration date as occurring when the local transaction frequency dropped below the predetermined threshold. In yet another example, the processing server 102 may identify transactions, including local and cross-border transactions, and may identify a date at which all transactions stop for the related transaction account, such as may indicate that the associated consumer 104 got a new transaction account in the second country 116. In such an instance, the processing server 102 may identify an immigration date at some point prior to the date at which transactions stopped, such as based on travel purchases, related transaction histories, etc.

In some embodiments, the transaction frequencies, periods of time, and thresholds may vary dependent on the individual consumer 104, the transaction behavior of the transaction account, the second country 116, etc. For example, if the consumer 104 regularly travels to foreign countries or regularly visits foreign countries for several weeks at a time, the periods of time may be greater than for a consumer 104 that does not frequently travel out of the country. In another example, if the second country 116 borders the first country 114, the threshold may be higher due to the ease of conducting transactions in the first country 114.

Once the immigration date has been identified, the processing server 102 may generate a predictive model for immigration based on the transaction behavior of the consumer 104 prior to the immigration date. The transaction behaviors may be based on analysis of the transaction data included in the transaction messages having transaction dates prior to the immigration date, and may include, for example, purchase behaviors related to transaction frequency, frequency of transactions with specific merchants or industries, transaction ticket size, ticket sizes for specific merchants or industries, changes in ticket size over time prior to the immigration date, propensities to transaction at specific merchants or in specific merchant industries, number of transactions in the second country 116, etc. For example, the transaction behavior prior to the immigration date may indicate an increase in average ticket size, an increase in travel to the second country 116, a decrease in grocery and entertainment purchase, and an increase in fast food purchases. The predictive model may be generated to account for these transaction behaviors to determine a likelihood of immigration based on comparison of transaction behaviors for a different consumer 104 to the transaction behaviors used to generate the model.

In some embodiments, the predictive model may be based on transaction behaviors for a plurality of different consumers 104 prior to respective immigration dates. In some instances, predictive models may also be specific to one or more countries. For example, a predictive model may be associated with transaction behaviors for a specific emigrating country (e.g., first country 114), a specific immigrating country (e.g., second country 116), or a specific combination of emigrating and immigrating country. In some instances, predictive models may be associated with multiple countries, such as based on similarities between predictive models and/or transaction behaviors for each of the countries, or similarities in country demographics.

In some instances, a predictive model may be generated as an equation, with purchase behaviors being associated with variables in the equation. In such an instance, purchase behaviors for a consumer 104 may be input into the equation as the variables included therein, with the equation producing a likelihood of immigration for the consumer 104 based on the associated purchase behaviors. In some instances, a predictive model may also be used to produce additional data further to the likelihood of immigration, such as an immigration country or likelihood thereof, immigration date or likelihood thereof, etc.

Once the predictive model or models are generated by the processing server 102, the processing server 102 may identify potential immigrating consumers 104 based thereon. For instance, a third party 120, such as a governmental agency, may electronically transmit a data signal to the processing server 102 that is superimposed with a request for immigration data, such as a predicted number of immigrants for the next month. The request may thus include the first country 114 indicated as the emigrating country, but may not specify any specific second country 116.

The processing server 102 may identify predictive models associated with the first country 114 as the emigrating country. The processing server 102 may also identify transaction messages for consumers 104 where the country of issuance for their payment card 106 is the first country 114. The processing server 102 may then analyze their transaction behaviors and apply the predictive model to the transaction behaviors for each of the consumers 104 to determine a likelihood of immigration for each of the consumers 104. The processing server 102 may identify a number of consumers likely to emigrate from the first country 114 based on the results of the predictive model. For instance, each consumer determined to be likely to emigrate from the first country 114 within a month may be consumers 104 whose transaction behavior matches those of consumers 104 used in generation of the predictive model who emigrated from the first country 114 a month prior to their respective immigration date.

By using transaction behaviors, the processing server 102 may generate predictive models that can not only identify when a consumer immigrates to a new country quicker than in traditional systems, but may be able to accurately predict when a consumer is going to immigrate to a new country in the future based on their transaction behavior prior to immigration. As a result, the systems and methods discussed herein may provide for faster, more accurate identification of consumer immigration using transactional data than is available with existing systems.

### Processing Server

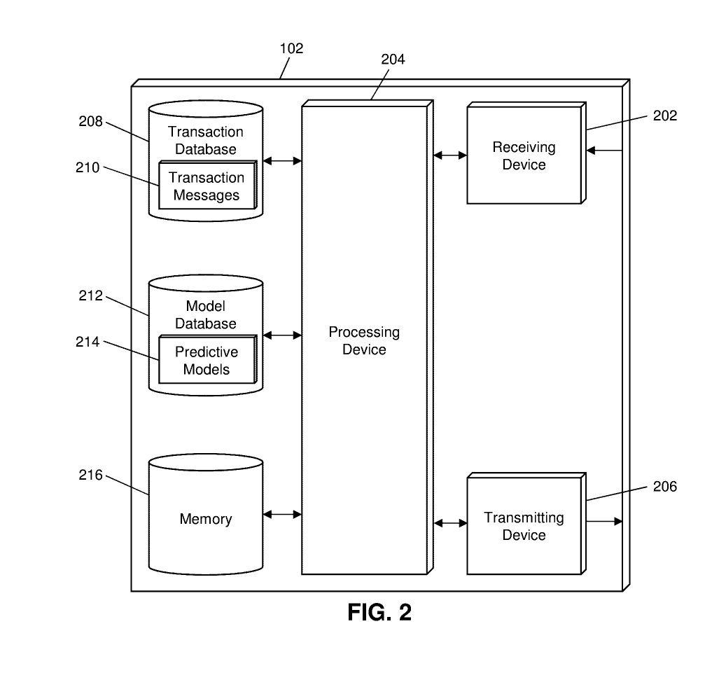

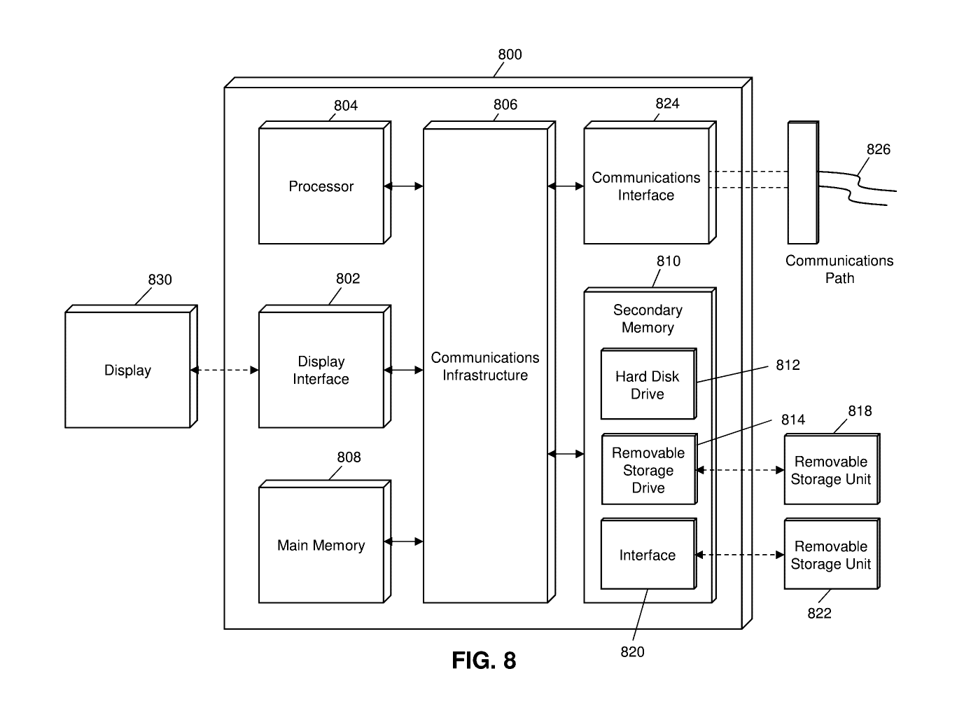

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 800 illustrated in FIG. 8 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 112 for the transmission of transaction messages that include sensitive financial data and information. In some instances, the receiving device 202 may also be configured to receive data from third parties 120 and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. The receiving device 202 may also be configured to receive data signals via application programming interfaces of the processing server 102 or an external computing device.

The receiving device 202 may be configured to receive transaction messages from the payment network 112. The transaction messages may be formatted based on one or more standards and include a plurality of data elements, and may be transmitted by the payment network 112 via the payment rails. The payment rails may be specialized infrastructure that a general purpose computing device may be unable to connect to, communicate with, and receive data from without specialized configuration and programming. The receiving device 202 may thus be specially configured to receive transaction messages from the payment network 112 and parse the transaction messages to identify the data stored in data elements included therein. The receiving device 202 may also be configured to receive data signals superimposed with data from third parties 120. Data received from third parties 120 may include, for example, consumer immigration data requests, which may be requests for predictive analysis of consumer immigrations likelihoods for groups of consumers or individual consumers, and may specify an emigrating country, immigrating country, or both.

The processing server 102 may also include a processing device 204. The processing device 204 may be configured to perform the functions of the processing server 102 discussed herein as will be apparent to persons having skill in the relevant art. In some embodiments, the processing device 204 may include and/or be comprised of a plurality of engines and/or modules specially configured to perform one or more functions of the processing device 204. For example, the processing device 204 may include a querying module configured to query databases included in the processing server 102 to identify information stored therein. In some instances, the processing device 204 may include a parsing module or engine configured to parse data from data signals electronically received by the receiving device 202, an encryption module or engine configured to decrypt received data or data signals or to encrypt data or data signals received or transmitted by the processing server 102, and any other modules suitable for performing the functions discussed herein.

The processing server 102 may also include a transaction database 208. The transaction database 208 may be configured to store a plurality of transaction messages 210 using an appropriate data stored format and schema. Each transaction message 210 may include a standardized data set related to a payment transaction, which may be specified based on one or more standard governing the exchange and storage of transaction data, such as the ISO 8583 standard. Each transaction message 210 may include a plurality of data elements including at least a first data element configured to store a primary account number, a second data element configured to store a merchant country, a third data element configured to store an issuing financial institution country, a fourth data element configured to store a transaction date, and one or more additional data elements configured to store additional transaction data.

The processing device 204 may be configured to generate predictive models based on the transaction messages 210 stored in the transaction database 208. A querying module of the processing device 204 may execute a query on the transaction database 208 to identify a subset of transaction messages 210 that include a common primary account number stored in the first data element included therein, where the common primary account number is associated with a payment card 106 for a consumer 104. The querying module may accept a query string or one or more parameters for inclusion thereof, may execute the query, and may output data sets and/or date values identified as a result thereof. The processing device 204 may also include a categorization module that may categorize the subset of transaction messages 210 into two separate groups of transaction messages based on the issuing financial institution country and each of the merchant countries included therein, wherein each group corresponds to either local transactions or cross-border transactions. The categorization module may receive the transaction messages 210 as input, may perform the categorization, and may output the separated transaction message groups. In some embodiments, the querying module may execute two separate queries, a first to identify transaction messages 210 for the first group, and a second to identify transaction messages 210 for the second group.

The processing device 204 may also include an analytic module or engine configured to analyze the transaction messages 210 in each of the two groups to identify an immigration date. As discussed above, the immigration date may be based on frequencies of local transaction and cross-border transactions based on time, as determined from the transaction date stored in the corresponding data element in each transaction message, as well as a transaction date at which all transactions involving the associated transaction account stop, if applicable, such as in instances where the related consumer 104 has closed the transaction account following immigration. The analytic module may receive the transaction messages 210 in the groups, may perform the analysis, and may output the identified immigration date. Once the immigration date is identified, the analytic module may analyze the transaction data stored in the additional data elements of each transaction message 210 having a transaction date before the immigration date to generate transaction behaviors. The analytic module may utilize the transaction message 210 as input and may determine the transaction behaviors, which may be provided as output of the module. A model generation module or engine of the processing device 204 may use the transaction behaviors (e.g., received as input to the model generation module) to generate a predictive model to predict a likelihood of immigration for a consumer based on the transaction behaviors. The model generation module may produce the predictive model as output of the module's processes. In some instances, the predictive model may be based on transaction behaviors for a plurality of consumers 104. In some embodiments, each predictive model may be associated with an emigrating country, an immigrating country, or both, and may be based on transaction behaviors for consumers associated with the respective country or countries.

The processing server 102 may also include a model database 212. The model database 212 may be configured to store one or more predictive models 214 using an appropriate data storage format and schema. Each predictive model 214 may be configured to determine a likelihood of immigration for a consumer 104 based on application thereof to transaction behaviors for the consumer 104. In some instances, a predictive model 214 may be associated with a specific emigrating country, a specific immigration country, or both. The processing device 204 may be configured to store generated predictive models in the model database 212 as predictive models 214, for use in estimating consumer immigration based on transaction behaviors.

The processing device 204 may also be configured to apply predictive models 214 to consumer transaction behaviors to identify likelihoods of immigration. For instance, the querying module of the processing device 204 may execute a query on the transaction database 208 to identify a plurality of transaction messages 210 associated with a consumer 104, the transaction messages 210 each including a first data element storing a common primary account number associated with the consumer 104. The analytic module may then determine transaction behaviors for the consumer 104 based on the transaction data included in the identified transaction messages 210. The analytic module may also determine an emigrating country for the consumer 104 based on the issuing financial institution country stored in the corresponding data element in the identified transaction messages 210, and one or more immigrating countries based on merchant countries stored in the corresponding data element in the transaction messages 210 that are determined to be cross-border transactions.

The querying module may execute a query on the model database 212 to identify one or more predictive models 214, each predictive model 214 including an emigrating country associated with the determined emigrating country, and where each predictive model includes an immigrating country that corresponds to one of the one or more determined immigrating countries. A prediction module or engine of the processing server 102 may then apply the identified predictive models 214 to the transaction behaviors for the consumer 104 to identify a likelihood of immigration for the consumer 104 to move from the emigrating country to the respective immigrating country.

The processing server 102 may further include a transmitting device 206. The transmitting device 206 may be configured to transmit data over one or more networks via one or more network protocols. In some embodiments, the transmitting device 206 may be configured to transmit data over the payment rails, such as using specially configured infrastructure associated with payment networks 112 for the transmission of transaction messages that include sensitive financial data and information, such as identified payment credentials. In some instances, the transmitting device 206 may be configured to transmit data to consumer devices 104, digital entities 106, third parties 108, merchants 110, and other entities via alternative networks, such as the Internet. In some embodiments, the transmitting device 206 may be comprised of multiple devices, such as different transmitting devices for transmitting data over different networks, such as a first transmitting device for transmitting data over the payment rails and a second transmitting device for transmitting data over the Internet. The transmitting device 206 may electronically transmit data signals that have data superimposed that may be parsed by a receiving computing device. In some instances, the transmitting device 206 may include one or more modules for superimposing, encoding, or otherwise formatting data into data signals suitable for transmission.

The transmitting device 206 may be configured to transmit data signals to third parties 120 that are superimposed with data. For instance, the transmitting device 206 may transmit data signals superimposed with consumer immigration data, including predictions of numbers of consumers, consumer likelihoods to emigrate or immigrate, countries of emigration or immigration, etc. In some embodiments, the transmitting device 206 may also be configured to transmit data signals superimposed with requests for transaction data to the payment network 112.

The processing server 102 may also include a memory 216. The memory 216 may be configured to store data for use by the processing server 102 in performing the functions discussed herein. The memory 216 may be configured to store data using suitable data formatting methods and schema and may be any suitable type of memory, such as read-only memory, random access memory, etc. The memory 216 may include, for example, encryption keys and algorithms, communication protocols and standards, data formatting standards and protocols, program code for modules and application programs of the processing device 204, and other data that may be suitable for use by the processing server 102 in the performance of the functions disclosed herein as will be apparent to persons having skill in the relevant art.

### Process for Generation of a Predictive Model

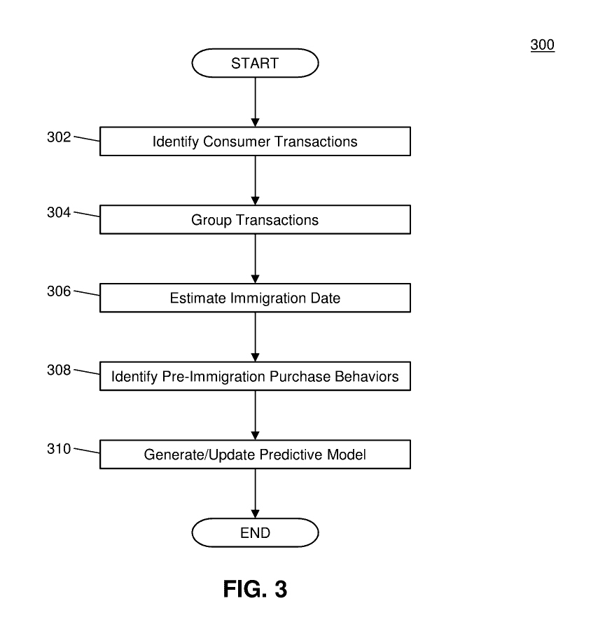

FIG. 3 illustrates a process 300 for the generation of a predictive model used to identify a likelihood of consumer immigration based on transaction behaviors.

In step 302, the querying module of the processing device 204 of the processing server 102 may execute a query on the transaction database 208 to identify transaction messages 210 involving a specific consumer 104. The transaction messages 210 may be identified based on the primary account number being stored in the corresponding data element of the respective transaction message 210 being a common primary account number associated with the specific consumer 104.

In step 304, the categorization module of the processing device 204 may group the identified transaction messages 210 into two groups. The first group may consist of local transactions where the issuing financial institution country and merchant country stored in their respective data elements of the transaction message 210 are the same. The second group may consist of cross-border transactions where the merchant country stored in the corresponding data element is different from the issuing financial institution country stored in the corresponding data element of the transaction message 210.

In step 306, the analytic module of the processing device 204 may estimate an immigration date for the specific consumer 104. The immigration date may be based on at least changes in a frequency of local transactions compared to a frequency of cross-border transactions for the specific consumer 104. In some embodiments, the immigration date may be further based on the frequency of local transactions compared to a predetermined threshold, transaction behaviors as compared to frequency of local and/or cross-border transactions, and other criteria.

In step 308, the analytic module of the processing device 204 may analyze the transaction data stored in the data elements of each transaction message 210 having a transaction date stored in the corresponding data element that is before the estimated immigration date, to generate a plurality of purchase behaviors. In step 310, the model generation module may generate a predictive model based on the generated purchase behaviors. In some embodiments, the predictive model may be associated with the issuing financial institution country as the emigrating country, and/or the merchant country for the cross-border transactions as the immigrating country. In some instances, the purchase behaviors may be used to update an existing predictive model 214 that is associated with the same emigrating country and/or immigrating country.

### Process for Estimation of Consumer Immigration

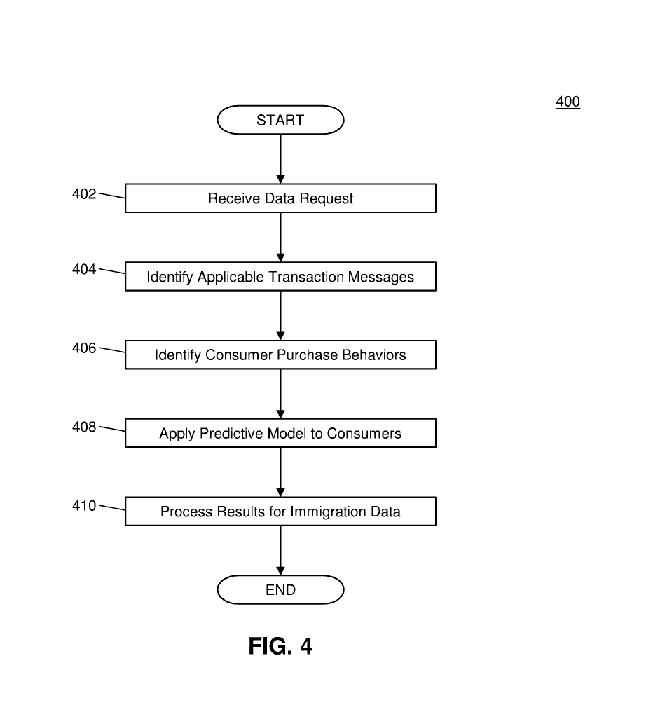

FIG. 4 illustrates a process 400 for the estimation of consumer immigration based on application of consumer purchase behaviors to predictive models configured to determine immigration likelihood.

In step 402, the receiving device 202 of the processing server 102 may receive a data signal superimposed with a data request from a third party 120. The receiving device 202 or a parsing module of the processing device 204 of the processing server 102 may parse the data signal to obtain the data request superimposed therein, which may request immigration data. The immigration data may include the type of data request, such as number of immigrants, number of emigrants, likely countries of emigration, likely countries of immigration, etc. The immigration data may also specify an emigration country and/or an immigration country.

In step 404, the querying module of the processing device 204 may execute a query on the transaction database 208 to identify applicable transaction messages 210. Applicable transaction messages 210 may be transaction messages that fit the criteria of the data request, such as transaction messages 210 involving a specific consumer 104 (e.g., based on the primary account number stored in the corresponding data element), transaction messages 210 involving a specific issuing financial institution country, transaction messages 210 involving a specific merchant country, all transaction messages 210 involving a consumer 104 that has one or more transaction messages involving a specific issuing financial institution country and/or merchant country, etc.

In step 406, the analytic module of the processing device 204 may analyze the transaction messages 210 to determine purchase behaviors for each of the consumers 104 associated with the transaction messages 210. In some embodiments, purchase behaviors may be determined for each individual consumer 104 based on the transaction data in transaction messages 210 associated with that individual consumer 104. In step 408, the querying module of the processing device 204 may execute a query on the model database 212 to identify one or more predictive models 214 based on the immigration data being requested, and the prediction module of the processing device 204 may apply the model to the consumer purchase behaviors to identify likelihoods of immigration for each of the consumers 104.

In step 410, the prediction module may process the results of the application of the predictive model to the consumer purchase behaviors to identify the immigration data requested in the data request from the third party 120. For example, if the immigration data requested is for the number of consumers predicted to immigrate to each different country from a specific emigrating country, the prediction module may analyze the consumer likelihood for each consumer to immigrate to each potential immigrating country and may determine the number of consumers accordingly. The transmitting device 206 of the processing server 102 may electronically transmit a data signal superimposed with the identified immigration data to the third party 120. The third party 120 may then use the data accordingly. For example, a governmental agency may base policy, budgeting, resources, etc. based on emigration or immigration data.

### Exemplary Method for Predictive Modeling of Consumer Immigration

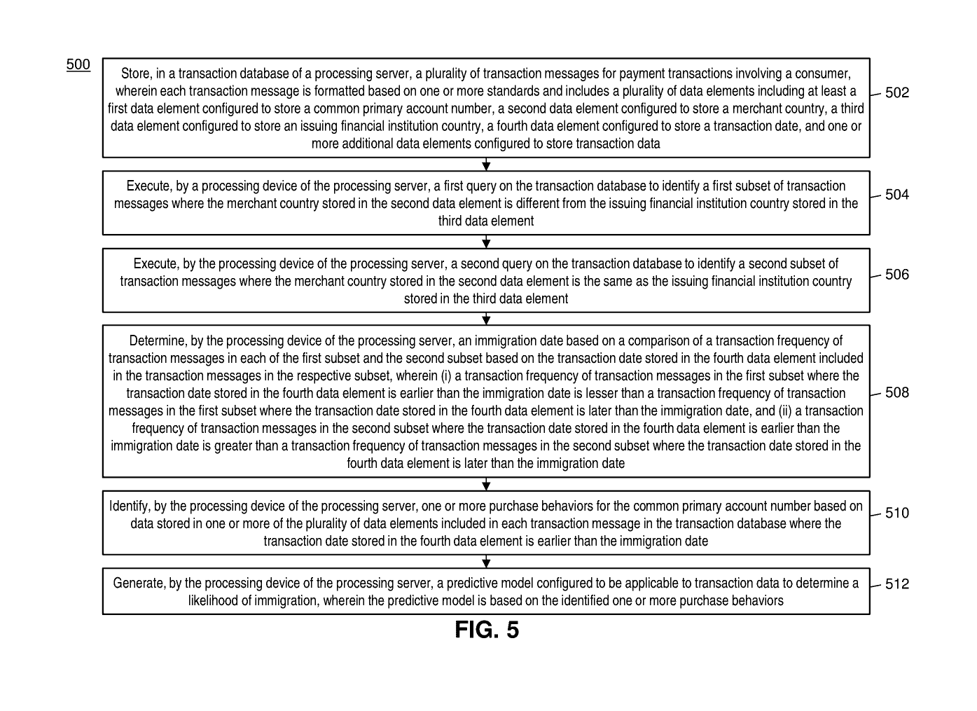

FIG. 5 illustrates a method 500 for the generation of a predictive model for consumer immigration based on consumer purchase behaviors derived from transactional data.

In step 502, a plurality of transaction messages (e.g., transaction messages 210) for payment transactions involving a consumer (e.g., the consumer 104) may be stored in a transaction database (e.g., the transaction database 208) of a processing server (e.g., the processing server 102), wherein each transaction message is formatted based on one or more standards and includes a plurality of data elements including at least a first data element configured to store a common primary account number, a second data element configured to store a merchant country, a third data element configured to store an issuing financial institution country, a fourth data element configured to store a transaction date, and one or more additional data elements configured to store transaction data. In step 504, a first query may be executed by a processing device (e.g., the processing device 204) of the processing server on the transaction database to identify a first subset of transaction messages where the merchant country stored in the second data element is different from the issuing financial institution country stored in the third data element.

In step 506, a second query may be executed by the processing device of the processing server on the transaction database to identify a second subset of transaction messages where the merchant country stored in the second data element is the same as the issuing financial institution country stored in the third data element. In step 508, an immigration date may be determined by the processing device of the processing server based on a comparison of a transaction frequency of transaction messages in each of the first subset and the second subset based on the transaction date stored in the fourth data element included in the transaction messages in the respective subset, wherein (i) a transaction frequency of transaction messages in the first subset where the transaction date stored in the fourth data element is earlier than the immigration date is lesser than a transaction frequency of transaction messages in the first subset where the transaction date stored in the fourth data element is later than the immigration date, and (ii) a transaction frequency of transaction messages in the second subset where the transaction date stored in the fourth data element is earlier than the immigration date is greater than a transaction frequency of transaction messages in the second subset where the transaction date stored in the fourth data element is later than the immigration date.

In step 510, one or more purchase behaviors may be identified by the processing device of the processing server for the common primary account number based on data stored in one or more of the plurality of data elements included in each transaction message in the transaction database where the transaction date stored in the fourth data element is earlier than the immigration date. In step 512, a predictive model may be generated by the processing device of the processing server, wherein the predictive model is configured to be applicable to transaction data to determine a likelihood of immigration and is based on the identified one or more purchase behaviors.

In some embodiments, the merchant country stored in the second data element of each transaction message in the first subset of transaction messages may be the same country. In one embodiment, the method 500 may also include receiving, by a receiving device (e.g., the receiving device 202) of the processing server, the plurality of transaction messages via a payment network (e.g., the payment network 112), wherein each of the transaction messages are electronically transmitted via one or more communication protocols associated with the one or more standards.

In some embodiments, the method 500 may further include repeating, by the processing device of the processing server, the executing, determining, and identifying steps for a plurality of transaction messages stored in the transaction database where the first data element includes a different common primary account number, wherein the predictive model is further based on a correspondence of the one or more purchase behaviors identified for the common primary account number to the one or more purchase behaviors identified for the different common primary account number. In a further embodiment, the merchant country stored in the second data element and the issuing financial institution country stored in the third data element of each transaction message in the first subset of transaction messages identified for the common primary account number is the same as the merchant country stored in the second data element and the issuing financial institution country stored in the third data element of each transaction message in the first subset of transaction messages identified for the different common primary account number.

### Exemplary Method for Identification of Potential Immigrating Consumers Using Predictive Modeling

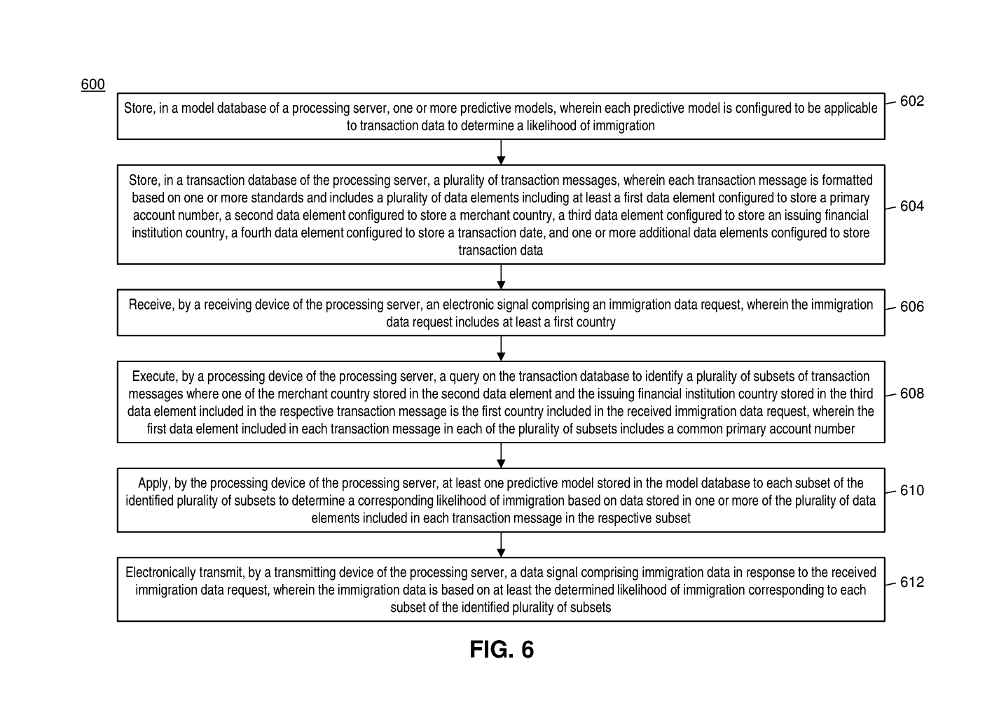

FIG. 6 illustrates a method 600 for the identification of likelihoods of consumer immigration based on transactional data applied to predictive modeling.

In step 602, one or more predictive models (e.g., predictive models 214) may be stored in a model database (e.g., model database 212) of a processing server (e.g., processing server 102), wherein each predictive model is configured to be applicable to transaction data to determine a likelihood of immigration. In step 604, a plurality of transaction messages (e.g., transaction messages 210) may be stored in a transaction database (e.g., the transaction database 208) of the processing server, wherein each transaction message is formatted based on one or more standards and includes a plurality of data elements including at least a first data element configured to store a primary account number, a second data element configured to store a merchant country, a third data element configured to store an issuing financial institution country, a fourth data element configured to store a transaction date, and one or more additional data elements configured to store transaction data.

In step 606, an electronic signal comprising an immigration data request may be received by a receiving device (e.g., the receiving device 202) of the processing server, wherein the immigration data request includes at least a first country (e.g., first country 114). In step 608, a processing device (e.g., the processing device 204) of the processing server 102 may execute a query on the transaction database to identify a plurality of subsets of transaction messages where one of the merchant country stored in the second data element and the issuing financial institution country stored in the third data element included in the respective transaction message is the first country included in the received immigration data request, wherein the first data element included in each transaction message in each of the plurality of subsets includes a common primary account number.

In step 610, at least one predictive model stored in the model database may be applied by the processing device of the processing server to each subset of the identified plurality of subsets to determine a corresponding likelihood of immigration based on data stored in one or more of the plurality of data elements included in each transaction message in the respective subset. In step 612, a data signal comprising immigration data may be electronically transmitted by a transmitting device (e.g., the transmitting device 202) of the processing server in response to the received immigration data request, wherein the immigration data is based on at least the determined likelihood of immigration corresponding to each subset of the identified plurality of subsets.

In one embodiment, each predictive model of the one or more predictive models may be associated with an emigration country and an immigration country, and one of the emigration country and immigration country associated with the at least one predictive model may be the first country. In some embodiments, the immigration data request may specify the first country as one of the merchant country and the issuing financial institution country.

In one embodiment, the immigration data request may further include a second country, the merchant country stored in the second data element included in the transaction message in each subset of transaction messages may be the first country, and the issuing financial institution country stored in the third data element included in the transaction message in each subset of transaction messages may be the second country. In some embodiments, the method 600 may also include identifying, by the processing device of the processing server, one or more purchase behaviors for each subset of transaction messages based on data stored in one or more of the plurality of data elements included in each transaction message in the respective subset, wherein the at least one predictive model is applied to the one or more purchase behaviors identified for the respective subset of transaction messages.

### Payment Transaction Processing System and Process

FIG. 7 illustrates a transaction processing system and a process 700 for the processing of payment transactions in the system. The process 700 and steps included therein may be performed by one or more components of the system 100 discussed above, such as the consumer 104, merchants 110 and 118, processing server 102, payment network 112, and issuer 108. The processing of payment transactions using the system and process 700 illustrated in FIG. 7 and discussed below may utilize the payment rails, which may be comprised of the computing devices and infrastructure utilized to perform the steps of the process 700 as specially configured and programmed by the entities discussed below, including the transaction processing server 712, which may be associated with one or more payment networks configured to processing payment transactions. It will be apparent to persons having skill in the relevant art that the process 700 may be incorporated into the processes illustrated in FIGS. 3-6, discussed above, with respect to the step or steps involved in the processing of a payment transaction. In addition, the entities discussed herein for performing the process 500 may include one or more computing devices or systems configured to perform the functions discussed below. For instance, the merchant 504 may be comprised of one or more point of sale devices, a local communication network, a computing server, and other devices configured to perform the functions discussed below.

In step 720, an issuing financial institution 702 may issue a payment card or other suitable payment instrument to a consumer 704. The issuing financial institution may be a financial institution, such as a bank, or other suitable type of entity that administers and manages payment accounts and/or payment instruments for use with payment accounts that can be used to fund payment transactions. The consumer 704 may have a transaction account with the issuing financial institution 702 for which the issued payment card is associated, such that, when used in a payment transaction, the payment transaction is funded by the associated transaction account. In some embodiments, the payment card may be issued to the consumer 704 physically. In other embodiments, the payment card may be a virtual payment card or otherwise provisioned to the consumer 704 in an electronic format.

In step 722, the consumer 704 may present the issued payment card to a merchant 706 for use in funding a payment transaction. The merchant 706 may be a business, another consumer, or any entity that may engage in a payment transaction with the consumer 704. The payment card may be presented by the consumer 704 via providing the physical card to the merchant 706, electronically transmitting (e.g., via near field communication, wireless transmission, or other suitable electronic transmission type and protocol) payment details for the payment card, or initiating transmission of payment details to the merchant 706 via a third party. The merchant 706 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 724, the merchant 706 may enter transaction details into a point of sale computing system. The transaction details may include the payment details provided by the consumer 704 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 706 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 706 may be an online retailer in an e-commerce transaction. In such embodiments, the transaction details may be entered in a shopping cart or other repository for storing transaction data in an electronic transaction as will be apparent to persons having skill in the relevant art.

In step 726, the merchant 706 may electronically transmit a data signal superimposed with transaction data to a gateway processor 708. The gateway processor 708 may be an entity configured to receive transaction details from a merchant 706 for formatting and transmission to an acquiring financial institution 710. In some instances, a gateway processor 708 may be associated with a plurality of merchants 706 and a plurality of acquiring financial institutions 710. In such instances, the gateway processor 708 may receive transaction details for a plurality of different transactions involving various merchants, which may be forwarded on to appropriate acquiring financial institutions 710. By having relationships with multiple acquiring financial institutions 710 and having the requisite infrastructure to communicate with financial institutions using the payment rails, such as using application programming interfaces associated with the gateway processor 508 or financial institutions used for the submission, receipt, and retrieval of data, a gateway processor 708 may act as an intermediary for a merchant 706 to be able to conduct payment transactions via a single communication channel and format with the gateway processor 708, without having to maintain relationships with multiple acquiring financial institutions 710 and payment processors and the hardware associated thereto. Acquiring financial institutions 710 may be financial institutions, such as banks, or other entities that administers and manages payment accounts and/or payment instruments for use with payment accounts. In some instances, acquiring financial institutions 710 may manage transaction accounts for merchants 706. In some cases, a single financial institution may operate as both an issuing financial institution 702 and an acquiring financial institution 710.

The data signal transmitted from the merchant 706 to the gateway processor 708 may be superimposed with the transaction details for the payment transaction, which may be formatted based on one or more standards. In some embodiments, the standards may be set forth by the gateway processor 708, which may use a unique, proprietary format for the transmission of transaction data to/from the gateway processor 708. In other embodiments, a public standard may be used, such as the International Organization for Standardization's ISO 8783 standard. The standard may indicate the types of data that may be included, the formatting of the data, how the data is to be stored and transmitted, and other criteria for the transmission of the transaction data to the gateway processor 708.

In step 728, the gateway processor 708 may parse the transaction data signal to obtain the transaction data superimposed thereon and may format the transaction data as necessary. The formatting of the transaction data may be performed by the gateway processor 708 based on the proprietary standards of the gateway processor 708 or an acquiring financial institution 710 associated with the payment transaction. The proprietary standards may specify the type of data included in the transaction data and the format for storage and transmission of the data. The acquiring financial institution 710 may be identified by the gateway processor 708 using the transaction data, such as by parsing the transaction data (e.g., deconstructing into data elements) to obtain an account identifier included therein associated with the acquiring financial institution 710. In some instances, the gateway processor 708 may then format the transaction data based on the identified acquiring financial institution 710, such as to comply with standards of formatting specified by the acquiring financial institution 710. In some embodiments, the identified acquiring financial institution 710 may be associated with the merchant 706 involved in the payment transaction, and, in some cases, may manage a transaction account associated with the merchant 706.

In step 730, the gateway processor 708 may electronically transmit a data signal superimposed with the formatted transaction data to the identified acquiring financial institution 710. The acquiring financial institution 710 may receive the data signal and parse the signal to obtain the formatted transaction data superimposed thereon. In step 732, the acquiring financial institution may generate an authorization request for the payment transaction based on the formatted transaction data. The authorization request may be a specially formatted transaction message that is formatted pursuant to one or more standards, such as the ISO 8783 standard and standards set forth by a payment processor used to process the payment transaction, such as a payment network. The authorization request may be a transaction message that includes a message type indicator indicative of an authorization request, which may indicate that the merchant 706 involved in the payment transaction is requesting payment or a promise of payment from the issuing financial institution 702 for the transaction. The authorization request may include a plurality of data elements, each data element being configured to store data as set forth in the associated standards, such as for storing an account number, application cryptogram, transaction amount, issuing financial institution 702 information, etc.

In step 734, the acquiring financial institution 710 may electronically transmit the authorization request to a transaction processing server 712 for processing. The transaction processing server 712 may be comprised of one or more computing devices as part of a payment network configured to process payment transactions. In some embodiments, the authorization request may be transmitted by a transaction processor at the acquiring financial institution 710 or other entity associated with the acquiring financial institution. The transaction processor may be one or more computing devices that include a plurality of communication channels for communication with the transaction processing server 712 for the transmission of transaction messages and other data to and from the transaction processing server 712. In some embodiments, the payment network associated with the transaction processing server 712 may own or operate each transaction processor such that the payment network may maintain control over the communication of transaction messages to and from the transaction processing server 712 for network and informational security.

In step 736, the transaction processing server 712 may perform value-added services for the payment transaction. Value-added services may be services specified by the issuing financial institution 702 that may provide additional value to the issuing financial institution 702 or the consumer 704 in the processing of payment transactions. Value-added services may include, for example, fraud scoring, transaction or account controls, account number mapping, offer redemption, loyalty processing, etc. For instance, when the transaction processing server 712 receives the transaction, a fraud score for the transaction may be calculated based on the data included therein and one or more fraud scoring algorithms and/or engines. In some instances, the transaction processing server 712 may first identify the issuing financial institution 702 associated with the transaction, and then identify any services indicated by the issuing financial institution 702 to be performed. The issuing financial institution 702 may be identified, for example, by data included in a specific data element included in the authorization request, such as an issuer identification number. In another example, the issuing financial institution 702 may be identified by the primary account number stored in the authorization request, such as by using a portion of the primary account number (e.g., a bank identification number) for identification.

In step 738, the transaction processing server 712 may electronically transmit the authorization request to the issuing financial institution 702. In some instances, the authorization request may be modified, or additional data included in or transmitted accompanying the authorization request as a result of the performance of value-added services by the transaction processing server 712. In some embodiments, the authorization request may be transmitted to a transaction processor (e.g., owned or operated by the transaction processing server 712) situated at the issuing financial institution 702 or an entity associated thereof, which may forward the authorization request to the issuing financial institution 702.

In step 740, the issuing financial institution 702 may authorize the transaction account for payment of the payment transaction. The authorization may be based on an available credit amount for the transaction account and the transaction amount for the payment transaction, fraud scores provided by the transaction processing server 712, and other considerations that will be apparent to persons having skill in the relevant art. The issuing financial institution 702 may modify the authorization request to include a response code indicating approval (e.g., or denial if the transaction is to be denied) of the payment transaction. The issuing financial institution 702 may also modify a message type indicator for the transaction message to indicate that the transaction message is changed to be an authorization response. In step 742, the issuing financial institution 740 may transmit (e.g., via a transaction processor) the authorization response to the transaction processing server 712.

In step 744, the transaction processing server 712 may forward the authorization response to the acquiring financial institution 710 (e.g., via a transaction processor). In step 746, the acquiring financial institution may generate a response message indicating approval or denial of the payment transaction as indicated in the response code of the authorization response, and may transmit the response message to the gateway processor 708 using the standards and protocols set forth by the gateway processor 708. In step 748, the gateway processor 708 may forward the response message to the merchant 706 using the appropriate standards and protocols. In step 770, the merchant 706 may then provide the products purchased by the consumer 704 as part of the payment transaction to the consumer 704.

In some embodiments, once the process 700 has completed, payment from the issuing financial institution 702 to the acquiring financial institution 710 may be performed. In some instances, the payment may be made immediately or within one business day. In other instances, the payment may be made after a period of time, and in response to the submission of a clearing request from the acquiring financial institution 710 to the issuing financial institution 702 via the transaction processing server 702. In such instances, clearing requests for multiple payment transactions may be aggregated into a single clearing request, which may be used by the transaction processing server 712 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 740), the transaction processing server 712 may be configured to perform authorization of transactions on behalf of the issuing financial institution. Such actions may be referred to as “stand-in processing,” where the transaction processing server “stands in” as the issuing financial institution 702. In such instances, the transaction processing server 712 may utilize rules set forth by the issuing financial institution 702 to determine approval or denial of the payment transaction, and may modify the transaction message accordingly prior to forwarding to the acquiring financial institution 710 in step 744. The transaction processing server 712 may retain data associated with transactions for which the transaction processing server 712 stands in, and may transmit the retained data to the issuing financial institution 702 once communication is reestablished. The issuing financial institution 702 may then process transaction accounts accordingly to accommodate for the time of lost communication.

In another example, if the transaction processing server 712 is unavailable for submission of the authorization request by the acquiring financial institution 710, then the transaction processor at the acquiring financial institution 710 may be configured to perform the processing of the transaction processing server 712 and the issuing financial institution 702. The transaction processor may include rules and data suitable for use in making a determination of approval or denial of the payment transaction based on the data included therein. For instance, the issuing financial institution 702 and/or transaction processing server 712 may set limits on transaction type, transaction amount, etc. that may be stored in the transaction processor and used to determine approval or denial of a payment transaction based thereon. In such instances, the acquiring financial institution 710 may receive an authorization response for the payment transaction even if the transaction processing server 712 is unavailable, ensuring that transactions are processed and no downtime is experienced even in instances where communication is unavailable. In such cases, the transaction processor may store transaction details for the payment transactions, which may be transmitted to the transaction processing server 712 (e.g., and from there to the associated issuing financial institutions 702) once communication is reestablished.

In some embodiments, transaction processors may be configured to include a plurality of different communication channels, which may utilize multiple communication cards and/or devices, to communicate with the transaction processing server 712 for the sending and receiving of transaction messages. For example, a transaction processor may be comprised of multiple computing devices, each having multiple communication ports that are connected to the transaction processing server 712. In such embodiments, the transaction processor may cycle through the communication channels when transmitting transaction messages to the transaction processing server 712, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 710 may identify that an authorization request involves an issuing financial institution 702 (e.g., via the bank identification number included in the transaction message) for which no value-added services are required. The transaction processor at the acquiring financial institution 710 may then transmit the authorization request directly to the transaction processor at the issuing financial institution 702 (e.g., without the authorization request passing through the transaction processing server 712), where the issuing financial institution 702 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 712 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 708, acquiring financial institution 710, etc.) for processing using this advanced network, and to quickly and efficiently receive a response regarding the ability for a consumer 704 to fund the payment transaction.

### Computer System Architecture

FIG. 8 illustrates a computer system 800 in which embodiments of the present disclosure, or portions thereof, may be implemented as computer-readable code. For example, the processing server 102 of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-7.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage device 818, a removable storage device 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. The processor device 804 may be connected to a communications infrastructure 806, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 may also include a main memory 808 (e.g., random access memory, read-only memory, etc.), and may also include a secondary memory 810. The secondary memory 810 may include the hard disk drive 812 and a removable storage drive 814, such as a floppy disk drive, a magnetic tape drive, an optical disk drive, a flash memory, etc.

The removable storage drive 814 may read from and/or write to the removable storage device 818 in a well-known manner. The removable storage device 818 may include a removable storage media that may be read by and written to by the removable storage drive 814. For example, if the removable storage drive 814 is a floppy disk drive or universal serial bus port, the removable storage device 818 may be a floppy disk or portable flash drive, respectively. In one embodiment, the removable storage device 818 may be non-transitory computer readable recording media.

In some embodiments, the secondary memory 810 may include alternative means for allowing computer programs or other instructions to be loaded into the computer system 800, for example, the removable storage device 822 and an interface 820. Examples of such means may include a program cartridge and cartridge interface (e.g., as found in video game systems), a removable memory chip (e.g., EEPROM, PROM, etc.) and associated socket, and other removable storage devices 822 and interfaces 820 as will be apparent to persons having skill in the relevant art.

Data stored in the computer system 800 (e.g., in the main memory 808 and/or the secondary memory 810) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 800 may also include a communications interface 824. The communications interface 824 may be configured to allow software and data to be transferred between the computer system 800 and external devices. Exemplary communications interfaces 824 may include a modem, a network interface (e.g., an Ethernet card), a communications port, a PCMCIA slot and card, etc. Software and data transferred via the communications interface 824 may be in the form of signals, which may be electronic, electromagnetic, optical, or other signals as will be apparent to persons having skill in the relevant art. The signals may travel via a communications path 826, which may be configured to carry the signals and may be implemented using wire, cable, fiber optics, a phone line, a cellular phone link, a radio frequency link, etc.

The computer system 800 may further include a display interface 802. The display interface 802 may be configured to allow data to be transferred between the computer system 800 and external display 830. Exemplary display interfaces 802 may include high-definition multimedia interface (HDMI), digital visual interface (DVI), video graphics array (VGA), etc. The display 830 may be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 808 and secondary memory 810, which may be memory semiconductors (e.g., DRAMs, etc.). These computer program products may be means for providing software to the computer system 800. Computer programs (e.g., computer control logic) may be stored in the main memory 808 and/or the secondary memory 810. Computer programs may also be received via the communications interface 824. Such computer programs, when executed, may enable computer system 800 to implement the present methods as discussed herein. In particular, the computer programs, when executed, may enable processor device 804 to implement the methods illustrated by FIGS. 3-7, as discussed herein. Accordingly, such computer programs may represent controllers of the computer system 800. Where the present disclosure is implemented using software, the software may be stored in a computer program product and loaded into the computer system 800 using the removable storage drive 814, interface 820, and hard disk drive 812, or communications interface 824.

The processor device 804 may comprise one or more modules or engines configured to perform the functions of the computer system 800. Each of the modules or engines may be implemented using hardware and, in some instances, may also utilize software, such as corresponding to program code and/or programs stored in the main memory 808 or secondary memory 810. In such instances, program code may be compiled by the processor device 804 (e.g., by a compiling module or engine) prior to execution by the hardware of the computer system 800. For example, the program code may be source code written in a programming language that is translated into a lower level language, such as assembly language or machine code, for execution by the processor device 804 and/or any additional hardware components of the computer system 800. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, systems and methods for generating predictive models for consumer immigration and use thereof in identifying consumer immigration. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for predictive modeling of consumer immigration, comprising:
storing, in a transaction database of a processing server, a plurality of transaction messages for payment transactions involving a consumer, wherein each transaction message is formatted based on one or more standards and includes a plurality of data elements including at least a first data element configured to store a common primary account number, a second data element configured to store a merchant country, a third data element configured to store an issuing financial institution country, a fourth data element configured to store a transaction date, and one or more additional data elements configured to store transaction data;
executing, by a processing device of the processing server, a first query on the transaction database to identify a first subset of transaction messages where the merchant country stored in the second data element is different from the issuing financial institution country stored in the third data element;
executing, by the processing device of the processing server, a second query on the transaction database to identify a second subset of transaction messages where the merchant country stored in the second data element is the same as the issuing financial institution country stored in the third data element;
determining, by the processing device of the processing server, an immigration date based on a comparison of a transaction frequency of transaction messages in each of the first subset and the second subset based on the transaction date stored in the fourth data element included in the transaction messages in the respective subset, wherein (i) a transaction frequency of transaction messages in the first subset where the transaction date stored in the fourth data element is earlier than the immigration date is lesser than a transaction frequency of transaction messages in the first subset where the transaction date stored in the fourth data element is later than the immigration date, and (ii) a transaction frequency of transaction messages in the second subset where the transaction date stored in the fourth data element is earlier than the immigration date is greater than a transaction frequency of transaction messages in the second subset where the transaction date stored in the fourth data element is later than the immigration date;
identifying, by the processing device of the processing server, one or more purchase behaviors for the common primary account number based on data stored in one or more of the plurality of data elements included in each transaction message in the transaction database where the transaction date stored in the fourth data element is earlier than the immigration date; and
generating, by the processing device of the processing server, a predictive model configured to be applicable to transaction data to determine a likelihood of immigration, wherein the predictive model is based on the identified one or more purchase behaviors.

2. The method of claim 1, wherein the merchant country stored in the second data element of each transaction message in the first subset of transaction messages is the same country.

3. The method of claim 1, further comprising:
repeating, by the processing device of the processing server, the executing, determining, and identifying steps for a plurality of transaction messages stored in the transaction database where the first data element includes a different common primary account number, wherein
the predictive model is further based on a correspondence of the one or more purchase behaviors identified for the common primary account number to the one or more purchase behaviors identified for the different common primary account number.

4. The method of claim 3, wherein the merchant country stored in the second data element and the issuing financial institution country stored in the third data element of each transaction message in the first subset of transaction messages identified for the common primary account number is the same as the merchant country stored in the second data element and the issuing financial institution country stored in the third data element of each transaction message in the first subset of transaction messages identified for the different common primary account number.

5. The method of claim 1, further comprising:
receiving, by a receiving device of the processing server, the plurality of transaction messages via a payment network, wherein each of the transaction messages are electronically transmitted via one or more communication protocols associated with the one or more standards.

6. A method for identification of potential immigrating consumers using predictive modeling, comprising:
storing, in a model database of a processing server, one or more predictive models, wherein each predictive model is configured to be applicable to transaction data to determine a likelihood of immigration;
storing, in a transaction database of the processing server, a plurality of transaction messages, wherein each transaction message is formatted based on one or more standards and includes a plurality of data elements including at least a first data element configured to store a primary account number, a second data element configured to store a merchant country, a third data element configured to store an issuing financial institution country, a fourth data element configured to store a transaction date, and one or more additional data elements configured to store transaction data;
receiving, by a receiving device of the processing server, an electronic signal comprising an immigration data request, wherein the immigration data request includes at least a first country;
executing, by a processing device of the processing server, a query on the transaction database to identify a plurality of subsets of transaction messages where one of the merchant country stored in the second data element and the issuing financial institution country stored in the third data element included in the respective transaction message is the first country included in the received immigration data request, wherein the first data element included in each transaction message in each of the plurality of subsets includes a common primary account number;
applying, by the processing device of the processing server, at least one predictive model stored in the model database to each subset of the identified plurality of subsets to determine a corresponding likelihood of immigration based on data stored in one or more of the plurality of data elements included in each transaction message in the respective subset; and
electronically transmitting, by a transmitting device of the processing server, a data signal comprising immigration data in response to the received immigration data request, wherein the immigration data is based on at least the determined likelihood of immigration corresponding to each subset of the identified plurality of subsets.

7. The method of claim 6, wherein
each predictive model of the one or more predictive models is associated with an emigration country and an immigration country, and
one of the emigration country and immigration country associated with the at least one predictive model is the first country.

8. The method of claim 6, wherein
the immigration data request specifies the first country as one of the merchant country and the issuing financial institution country.

9. The method of claim 6, wherein
the immigration data request further includes a second country,
the merchant country stored in the second data element included in the transaction message in each subset of transaction messages is the first country, and
the issuing financial institution country stored in the third data element included in the transaction message in each subset of transaction messages is the second country.

10. The method of claim 6, further comprising:
identifying, by the processing device of the processing server, one or more purchase behaviors for each subset of transaction messages based on data stored in one or more of the plurality of data elements included in each transaction message in the respective subset, wherein
the at least one predictive model is applied to the one or more purchase behaviors identified for the respective subset of transaction messages.

11. A system for predictive modeling of consumer immigration, comprising:
a transaction database of a processing server configured to store a plurality of transaction messages for payment transactions involving a consumer, wherein each transaction message is formatted based on one or more standards and includes a plurality of data elements including at least a first data element configured to store a common primary account number, a second data element configured to store a merchant country, a third data element configured to store an issuing financial institution country, a fourth data element configured to store a transaction date, and one or more additional data elements configured to store transaction data; and
a processing device of the processing server configured to
execute a first query on the transaction database to identify a first subset of transaction messages where the merchant country stored in the second data element is different from the issuing financial institution country stored in the third data element,
execute a second query on the transaction database to identify a second subset of transaction messages where the merchant country stored in the second data element is the same as the issuing financial institution country stored in the third data element,
determine an immigration date based on a comparison of a transaction frequency of transaction messages in each of the first subset and the second subset based on the transaction date stored in the fourth data element included in the transaction messages in the respective subset, wherein (i) a transaction frequency of transaction messages in the first subset where the transaction date stored in the fourth data element is earlier than the immigration date is lesser than a transaction frequency of transaction messages in the first subset where the transaction date stored in the fourth data element is later than the immigration date, and (ii) a transaction frequency of transaction messages in the second subset where the transaction date stored in the fourth data element is earlier than the immigration date is greater than a transaction frequency of transaction messages in the second subset where the transaction date stored in the fourth data element is later than the immigration date,
identify one or more purchase behaviors for the common primary account number based on data stored in one or more of the plurality of data elements included in each transaction message in the transaction database where the transaction date stored in the fourth data element is earlier than the immigration date, and
generate a predictive model configured to be applicable to transaction data to determine a likelihood of immigration, wherein the predictive model is based on the identified one or more purchase behaviors.

12. The system of claim 11, wherein the merchant country stored in the second data element of each transaction message in the first subset of transaction messages is the same country.

13. The system of claim 11, wherein
the processing device of the processing server is further configured to repeat the executing, determining, and identifying steps for a plurality of transaction messages stored in the transaction database where the first data element includes a different common primary account number, and
the predictive model is further based on a correspondence of the one or more purchase behaviors identified for the common primary account number to the one or more purchase behaviors identified for the different common primary account number.

14. The system of claim 13, wherein the merchant country stored in the second data element and the issuing financial institution country stored in the third data element of each transaction message in the first subset of transaction messages identified for the common primary account number is the same as the merchant country stored in the second data element and the issuing financial institution country stored in the third data element of each transaction message in the first subset of transaction messages identified for the different common primary account number.

15. The system of claim 11, further comprising:
a receiving device of the processing server configured to receive the plurality of transaction messages via a payment network, wherein each of the transaction messages are electronically transmitted via one or more communication protocols associated with the one or more standards.

16. A system for identification of potential immigrating consumers using predictive modeling, comprising:
a model database of a processing server configured to store one or more predictive models, wherein each predictive model is configured to be applicable to transaction data to determine a likelihood of immigration;
a transaction database of the processing server configured to store a plurality of transaction messages, wherein each transaction message is formatted based on one or more standards and includes a plurality of data elements including at least a first data element configured to store a primary account number, a second data element configured to store a merchant country, a third data element configured to store an issuing financial institution country, a fourth data element configured to store a transaction date, and one or more additional data elements configured to store transaction data;
a receiving device of the processing server configured to receive an electronic signal comprising an immigration data request, wherein the immigration data request includes at least a first country;
a processing device of the processing server configured to
execute a query on the transaction database to identify a plurality of subsets of transaction messages where one of the merchant country stored in the second data element and the issuing financial institution country stored in the third data element included in the respective transaction message is the first country included in the received immigration data request, wherein the first data element included in each transaction message in each of the plurality of subsets includes a common primary account number, and
apply at least one predictive model stored in the model database to each subset of the identified plurality of subsets to determine a corresponding likelihood of immigration based on data stored in one or more of the plurality of data elements included in each transaction message in the respective subset; and
a transmitting device of the processing server configured to electronically transmit a data signal comprising immigration data in response to the received immigration data request, wherein the immigration data is based on at least the determined likelihood of immigration corresponding to each subset of the identified plurality of subsets.

17. The system of claim 16, wherein
each predictive model of the one or more predictive models is associated with an emigration country and an immigration country, and
one of the emigration country and immigration country associated with the at least one predictive model is the first country.

18. The system of claim 16, wherein
the immigration data request specifies the first country as one of the merchant country and the issuing financial institution country.

19. The system of claim 16, wherein
the immigration data request further includes a second country,
the merchant country stored in the second data element included in the transaction message in each subset of transaction messages is the first country, and
the issuing financial institution country stored in the third data element included in the transaction message in each subset of transaction messages is the second country.

20. The system of claim 16, wherein
the processing device of the processing server is further configured to identify one or more purchase behaviors for each subset of transaction messages based on data stored in one or more of the plurality of data elements included in each transaction message in the respective subset, and
the at least one predictive model is applied to the one or more purchase behaviors identified for the respective subset of transaction messages.
